(19) United States
(12) Patent Application Publication
(10) Pub. No.: US 2023/0101076 A1
(43) Pub. Date: Mar. 30, 2023

(54) COMPUTER ASSISTANCE IN A TRANSACTION WITH A FOREIGN CURRENCY

(71) Applicant: International Business Machines Corporation, Armonk, NY (US)

(72) Inventors: Jana H. Jenkins, Raleigh, NC (US); John A. Lyons, Ottawa (CA); Jeffrey A. Kusnitz, Campbell, CA (US)

(21) Appl. No.: 17/490,081

(22) Filed: Sep. 30, 2021

(51) Int. Cl. G06Q 20/38; G06Q 20/32; G06K 9/00

(52) U.S. Cl. CPC G06Q 20/381; G06Q 20/322; G06K 9/00671

(57) ABSTRACT

A computer-implemented method, a computer program product, and a computer system for computer assistance in a transaction with a foreign currency. The computer system receives from a user a picture of a foreign currency taken by the user using a mobile device, identifies the foreign currency, receives from the user a notification that a transaction is to be proceeded with the foreign currency, displays on the mobile device one or more ways of combining bills and coins for payment in the transaction, displays on the mobile device an amount of a domestic currency equivalent to an amount of the foreign currency needed for the payment in the transaction, receives from the user a user selected way of combining the bills and coins for the payment in the transaction, and displays on the mobile device one or more ways of change given to the user.

### BACKGROUND

The present invention relates generally to computer assistance, and more particularly to computer assistance in a transaction with a foreign currency.

When traveling abroad, a user often has to conduct transactions (e.g., buying goods and services) with a foreign currency. Some foreign currencies include coins in addition to bills. It can be difficult for a user to understand quickly how to give the appropriate amount and receive the correct change. Different countries have different banking systems. Many countries use different colors and sizes for note denominations.

There are currency converter apps and tools, which provide current conversion rates; however, the apps and tools do not help users dealing with an unfamiliar currency in wallets.

### SUMMARY

In one aspect, a computer-implemented method for computer assistance in a transaction with a foreign currency is provided. The method includes receiving, from a user, a picture of a foreign currency, where the picture of the foreign currency is taken by the user using a mobile device. The method further includes identifying the foreign currency. The method further includes receiving, from the user, a notification that a transaction is to be proceeded with the foreign currency. The method further includes displaying, on the mobile device, one or more ways of combining bills and coins for payment in the transaction, in response to determining that a user owned amount of the foreign currency is enough for payment in the transaction. The method further includes displaying, on the mobile device, an amount of a domestic currency equivalent to an amount of the foreign currency needed for the payment in the transaction. The method further includes receiving, from the user, a user selected way of combining the bills and coins for the payment in the transaction. The method further includes displaying, on the mobile device, one or more ways of change given to the user.

In another aspect, a computer program product for computer assistance in a transaction with a foreign currency is provided. The computer program product comprises a computer readable storage medium having program instructions embodied therewith, and the program instructions are executable by one or more processors. The program instructions are executable to: receive, from a user, a picture of a foreign currency, where the picture of the foreign currency is taken by the user using a mobile device; identify the foreign currency; receive, from the user, a notification that a transaction is to be proceeded with the foreign currency; display, on the mobile device, one or more ways of combining bills and coins for payment in the transaction, in response to determining that a user owned amount of the foreign currency is enough for payment in the transaction; display, on the mobile device, an amount of a domestic currency equivalent to an amount of the foreign currency needed for the payment in the transaction; receive, from the user, a user selected way of combining the bills and coins for the payment in the transaction; and display, on the mobile device, one or more ways of change given to the user.

In yet another aspect, a computer system for computer assistance in a transaction with a foreign currency is provided. The computer system comprises one or more processors, one or more computer readable tangible storage devices, and program instructions stored on at least one of the one or more computer readable tangible storage devices for execution by at least one of the one or more processors. The program instructions are executable to receive, from a user, a picture of a foreign currency, where the picture of the foreign currency is taken by the user using a mobile device. The program instructions are executable to identify the foreign currency. The program instructions are executable to receive, from the user, a notification that a transaction is to be proceeded with the foreign currency. The program instructions are executable to display, on the mobile device, one or more ways of combining bills and coins for payment in the transaction, in response to determining that a user owned amount of the foreign currency is enough for payment in the transaction. The program instructions are executable to display, on the mobile device, an amount of a domestic currency equivalent to an amount of the foreign currency needed for the payment in the transaction. The program instructions are executable to receive, from the user, a user selected way of combining the bills and coins for the payment in the transaction. The program instructions are executable to display, on the mobile device, one or more ways of change given to the user.

### BRIEF DESCRIPTION OF THE SEVERAL VIEWS OF THE DRAWINGS

FIG. 1 is a flowchart showing operational steps of computer assistance in a transaction with a foreign currency, in accordance with one embodiment of the present invention.

FIG. 2 is a diagram illustrating components of a computing device or server, in accordance with one embodiment of the present invention.

FIG. 3 depicts a cloud computing environment, in accordance with one embodiment of the present invention.

FIG. 4 depicts abstraction model layers in a cloud computing environment, in accordance with one embodiment of the present invention.

### DETAILED DESCRIPTION

Embodiment of the present invention disclose a system and method to help a user (e.g., a traveler) complete a transaction (e.g., vendor payment) with a foreign currency. The system and method provide computer assistance to a user while abroad during a transaction using a foreign currency.

Using a mobile device, the user (e.g., traveler abroad) takes a picture of the foreign currency (including bills and coins) that the user has procured. The mobile device may be, for example, an augmented reality, a mobile phone, or a wearable. Based on the amount of the transaction and the amount of the foreign currency the user owns, the system determines whether the user has enough amount of the foreign currency for the transaction. The system shows user what options of using the foreign currency in the transaction, i.e., the system shows user what combinations of bills and coins can be used for payment in the transaction. The system shows user the amount of user's domestic currency equivalent to the amount of the foreign currency spent in the transaction, i.e., the system shows the user how much the user would spend in user's domestic currency. Based on the equivalent amount of the original currency, the user determines whether the user proceeds the transaction. If the transaction is proceeded by the user, change (the user overpaid amount) may be given to the user; under this situation, the system shows user options of the change, i.e., the system shows user combinations of bills and coins in the change. The user takes a picture of actual change by using the mobile device. Receiving the picture of the actual change, the system determines whether the actual change is correct and then notifies the user. If the change is incorrect, the user will receive a new change and re-take a picture of the new change; the system receives the picture of the new change and determines whether the new change is correct. This process may be repeated until the correct change is given the user. If the change is correct, the system updates the amount of the foreign currency the user owns.

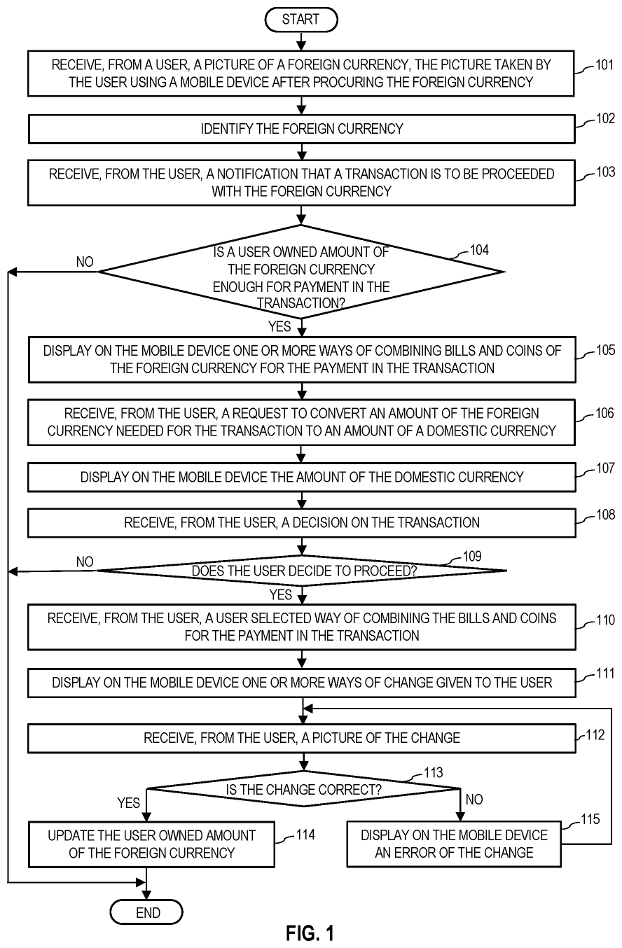

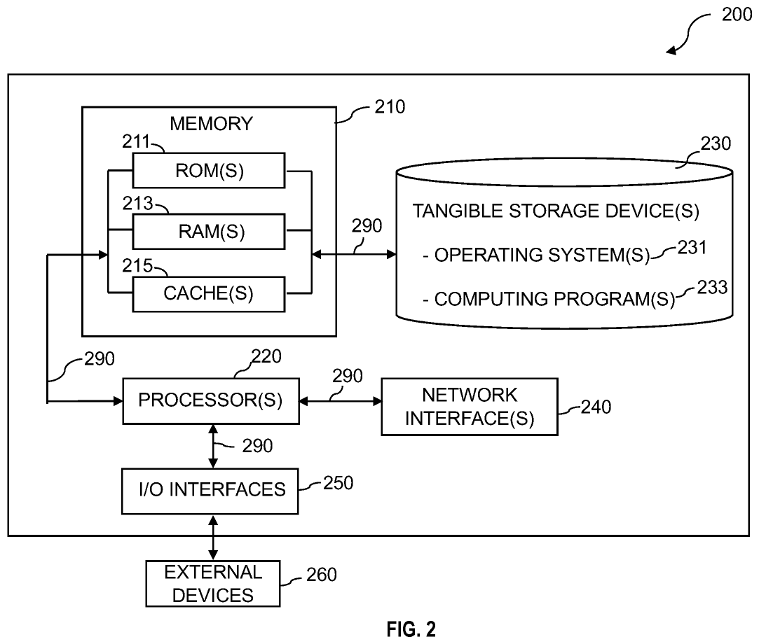

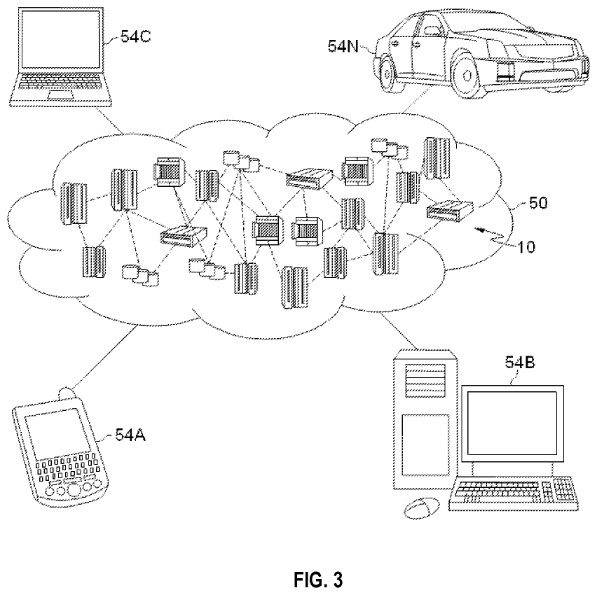

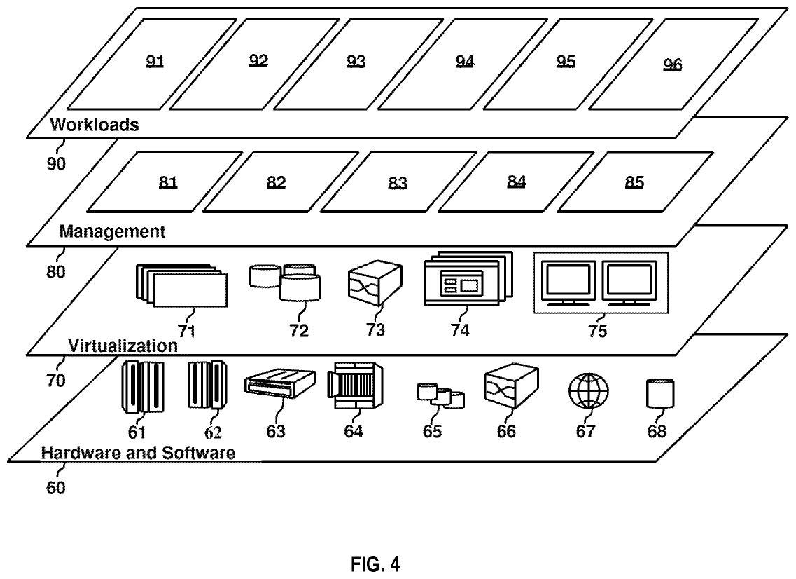

FIG. 1 is a flowchart showing operational steps of computer assistance in a transaction with a foreign currency, in accordance with one embodiment of the present invention. The operational steps are implemented by a system of computer assistance in a transaction with a foreign currency. The system is hosted on one or more computing devices or servers. A computing device or server is described in more detail in later paragraphs with reference to FIG. 2. The operational steps may be implemented by the system which is in a cloud computing environment. The cloud computing environment is described in more detail in later paragraphs with reference to FIG. 3 and FIG. 4.

At step 101, the system receives, from a user, a picture of a foreign currency, where the picture is taken by the user using a mobile device after procuring the foreign currency. The user travels abroad; when the user enters a foreign country or region, the user exchanges user's domestic currency to the foreign currency (including foreign bills and coins). After obtaining the foreign currency, the user takes a picture of the foreign bills and coins, using user's mobile device. The mobile device may be, for example, an augmented reality, a mobile phone, or a wearable. After taking the picture, the user sends the picture to the system.

At step 102, the system identifies the foreign currency. Upon receiving the picture of the foreign bills and coins, through identifying the foreign bills and coins, the system is aware of what the foreign currency the user has obtained and how much the foreign currency the user owns.

At step 103, the system receives, from the user, a notification that a transaction is to be proceeded with the foreign currency. For example, the user wants to pay for a motorbike rental for which a credit card or any electronic transaction is not acceptable and the foreign currency is only acceptable. By receiving the user's notification, the system is aware of how much is needed for the transaction with the foreign currency.

At step 104, the system determines whether a user owned amount of the foreign currency is enough for payment in the transaction. In response to determining that the user owned amount of the foreign currency is not enough for the payment in the transaction (NO branch of decision step 104), the system terminates the operational steps. The system may notify the user that the user owned amount of the foreign currency is not enough.

In response to determining that the user owned amount of the foreign currency is enough for the payment in the transaction (YES branch of decision step 104), at step 105, the system displays on the mobile device one or more ways of combining bills and coins of the foreign currency for the payment in the transaction.

At step 106, the system receives, from the user, a request to convert an amount of the foreign currency needed for the payment in the transaction to an amount of a domestic currency. Before the user makes a decision on whether the transaction is proceeded, the user wants to know the amount of the domestic currency needed for the payment in the transaction. At step 107, the system displays on the mobile device the amount of the domestic currency. The amount of domestic currency is equivalent to the amount of the foreign currency needed for the payment in the transaction and it gives information with which the user is familiar; thus, it will be easier for the user to make decision based on information about the amount of the domestic currency needed for the payment in the transaction. Then, the user sends through the mobile device a decision on proceeding the transaction. At step 108, the system receives, for the user, a decision on proceeding the transaction.

Upon receiving the decision from the user, at step 109, the system determines whether the user decides to proceed the transaction. In response to determining that user does not decide to proceed the transaction (NO branch of decision step 109), the system terminates the operational steps. The system may send a notification to the user's mobile device and inform the user that the transaction is not proceeded.

In response to determining that user decides to proceed the transaction (YES branch of decision step 109), at step 110, the system receives, form the user, a user selected way of combining the bills and coins for the payment in the transaction. From the one or more ways of combining bills and coins of the foreign currency for the payment (displayed by the system at step 105), the user selects one way of combining the bills and coins for the payment. The user makes the selection on the user's mobile device.

Using the user selected way of combining the bills and coins, the user proceeds the transaction. In the transaction, change may be given to the user, and the change may be given in different ways of combining the bills and coins. In a scenario when the change is involved, at step 111, the system displays on the mobile device one or more ways of change given to the user.

When the user receives the change, the user takes a picture of the change. At step 112, the system receives, from the user, the picture of the change. At step 113, the system determines whether the change is correct. In response to determining that the change is correct (YES branch of decision step 113), the system at step 114 updates the user owned amount of the foreign currency. The system subtracts the amount paid in the transaction from the previous total amount of the foreign currency. The system notifies the user that the change is correct and the transaction is completed. The system may also notify the user of the current balance of the foreign currency the user owns.

In response to determining that the change is incorrect (NO branch of decision step 113), at step 115, the system displays on the mobile device an error of the change. Upon notified by the system, the user will take an action to correct the error. During a process of correcting the error of the change, the system will reiterate steps 112 and 113 until determining that the change becomes correct.

FIG. 2 is a diagram illustrating components of computing device or server 200, in accordance with one embodiment of the present invention. It should be appreciated that FIG. 2 provides only an illustration of one implementation and does not imply any limitations; different embodiments may be implemented.

Referring to FIG. 2, computing device or server 200 includes processor(s) 220, memory 210, and tangible storage device(s) 230. In FIG. 2, communications among the above-mentioned components of computing device or server 200 are denoted by numeral 290. Memory 210 includes ROM(s) (Read Only Memory) 211, RAM(s) (Random Access Memory) 213, and cache(s) 215. One or more operating systems 231 and one or more computer programs 233 reside on one or more computer readable tangible storage device(s) 230.

Computing device or server 200 further includes I/O interface(s) 250. I/O interface(s) 250 allows for input and output of data with external device(s) 260 that may be connected to computing device or server 200. Computing device or server 200 further includes network interface(s) 240 for communications between computing device or server 200 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 3, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality of computer assistance in a transaction with a foreign currency.

1. A computer-implemented method for computer assistance in a transaction with a foreign currency, the method comprising:
receiving, from a user, a picture of bills and coins of a foreign currency, wherein the picture of the bills and coins of the foreign currency is taken by the user using a mobile device;
identifying the bills and coins of the foreign currency in the picture;
receiving, from the user, a notification that a transaction is to be proceeded with the foreign currency;
displaying, on the mobile device, one or more ways of combining the bills and coins for payment in the transaction, in response to determining that a user owned amount of the foreign currency is enough for payment in the transaction;
displaying, on the mobile device, an amount of a domestic currency equivalent to an amount of the foreign currency needed for the payment in the transaction;
receiving, from the user, a user selected way of combining the bills and coins for the payment in the transaction;
displaying, on the mobile device, one or more ways of change given to the user;
receiving, from the user, a picture of the change, wherein the picture of the change is taken by the user using the mobile device; and
determining whether the change is correct.

2. The computer-implemented method of claim 1, further comprising:
determining whether the user owned amount of the foreign currency is enough for the payment in the transaction.

3. The computer-implemented method of claim 1, further comprising:
receiving, from the user, a request to convert the amount of the foreign currency needed for the payment in the transaction to the amount of the domestic currency.

4. The computer-implemented method of claim 1, further comprising:
receiving, from the user, a decision on whether the user proceeds with the transaction.

5. (canceled)

6. The computer-implemented method of claim 1, further comprising:
in response to determining that the change is incorrect, displaying, on the mobile device, an error of the change.

7. The computer-implemented method of claim 1, further comprising:
in response to determining that the change is correct, updating the user owned amount of the foreign currency.

8. A computer program product for computer assistance in a transaction with a foreign currency, the computer program product comprising a computer readable storage medium having program instructions embodied therewith, the program instructions executable by one or more processors, the program instructions executable to:
receive, from a user, a picture of bills and coins of a foreign currency, wherein the picture of the bills and coins of the foreign currency is taken by the user using a mobile device;
identify the bills and coins of the foreign currency in the picture;
receive, from the user, a notification that a transaction is to be proceeded with the foreign currency;
display, on the mobile device, one or more ways of combining the bills and coins for payment in the transaction, in response to determining that a user owned amount of the foreign currency is enough for payment in the transaction;
display, on the mobile device, an amount of a domestic currency equivalent to an amount of the foreign currency needed for the payment in the transaction;
receive, from the user, a user selected way of combining the bills and coins for the payment in the transaction;
display, on the mobile device, one or more ways of change given to the user;
receive, from the user, a picture of the change, wherein the picture of the change is taken by the user using the mobile device; and
determine whether the change is correct.

9. The computer program product of claim 8, further comprising the program instructions executable to:
determine whether the user owned amount of the foreign currency is enough for the payment in the transaction.

10. The computer program product of claim 8, further comprising the program instructions executable to:
receive, from the user, a request to convert the amount of the foreign currency needed for the payment in the transaction to the amount of the domestic currency.

11. The computer program product of claim 8, further comprising the program instructions executable to:
receive, from the user, a decision on whether the user proceeds with the transaction.

12. (canceled)

13. The computer program product of claim 7, further comprising program instructions executable to:
in response to determining that the change is incorrect, display, on the mobile device, an error of the change.

14. The computer program product of claim 7, further comprising the program instructions executable to:
in response to determining that the change is correct, update the user owned amount of the foreign currency.

15. A computer system for computer assistance in a transaction with a foreign currency, the computer system comprising:
one or more processors, one or more computer readable tangible storage devices, and program instructions stored on at least one of the one or more computer readable tangible storage devices for execution by at least one of the one or more processors, the program instructions executable to:
receive, from a user, a picture of bills and coins of a foreign currency, wherein the picture of the bills and coins of the foreign currency is taken by the user using a mobile device;
identify the bills and coins of the foreign currency in the picture;
receive, from the user, a notification that a transaction is to be proceeded with the foreign currency;
display, on the mobile device, one or more ways of combining the bills and coins for payment in the transaction, in response to determining that a user owned amount of the foreign currency is enough for payment in the transaction;
display, on the mobile device, an amount of a domestic currency equivalent to an amount of the foreign currency needed for the payment in the transaction;
receive, from the user, a user selected way of combining the bills and coins for the payment in the transaction;
display, on the mobile device, one or more ways of change given to the user;
receive, from the user, a picture of the change, wherein the picture of the change is taken by the user using the mobile device; and
determine whether the change is correct.

16. The computer system of claim 15, further comprising the program instructions executable to:
determine whether the user owned amount of the foreign currency is enough for the payment in the transaction.

17. The computer system of claim 15, further comprising the program instructions executable to:
receive, from the user, a request to convert the amount of the foreign currency needed for the payment in the transaction to the amount of the domestic currency.

18. The computer system of claim 15, further comprising the program instructions executable to:
receive, from the user, a decision on whether the user proceeds with the transaction.

19. (canceled)

20. The computer system of claim 15, further comprising program instructions executable to:
in response to determining that the change is incorrect, display, on the mobile device, an error of the change; and
in response to determining that the change is correct, update the user owned amount of the foreign currency.
